(19) United States
(12) Patent Application Publication
(10) Pub. No.: US 2024/0081166 A1
(43) Pub. Date: Mar. 14, 2024

(54) AGRICULTURAL SUPPLY AND/OR MAINTENANCE FACILITY AND/OR ASSOCIATED SUPPLY AND/OR MAINTENANCE METHOD

(71) Applicant: KUHN SAS, Saverne (FR)

(72) Inventors: Benoît JARRASSIER, Ottersthal (FR); Philippe POTIER, Zittersheim (FR)

(73) Assignee: KUHN SAS, Saverne (FR)

(21) Appl. No.: 18/262,946

(22) PCT Filed: Feb. 1, 2022
(86) PCT No.: PCT/EP2022/052342

§ 371 Date: Jul. 26, 2023

(30) Foreign Application Priority Data
Feb. 5, 2021 (FR) FR2101107

(51) Int. Cl. A01B 69/04; A01B 59/00; A01B 59/04; A01B 69/00

(52) U.S. Cl. CPC A01B 69/008; A01B 59/002; A01B 59/04; A01B 69/004

(57) ABSTRACT

An agricultural facility arranged in a plot of farmland includes: a supply and/or maintenance station; an autonomous agricultural device performing an agricultural task in the plot of farmland; a control unit for moving the autonomous agricultural device and the station, which unit is configured to control movement of the autonomous agricultural device within the plot of farmland including a work area in which an agricultural task is performed by the autonomous agricultural device and an area to be worked in which an agricultural task is to be performed by the autonomous agricultural device. The control unit is configured to control movement of the station from the work area to the area to be worked if the autonomous agricultural device moves to perform an agricultural task in the area to be worked, movement of the station being independent from movement of the autonomous agricultural device.

The present invention relates to an agricultural supply and/or maintenance equipment and a supply and/or maintenance method.

When a plot of land is worked by a fleet of autonomous or highly automated vehicles, such as robots, various inputs supplies are required. Inputs can, for example, be selected from fuel, electrical energy, fertilizers, seeds, plant protection products, water, etc.

To guarantee that the vehicles are supplied, it is therefore essential to provide one or more supply stations. To optimize the movements of the vehicles going to obtain supplies, the supply station should ideally be located as close as possible to the vehicle to be supplied.

Several solutions are currently available to supply conventional agricultural machines, i.e. non-autonomous agricultural machines.

In particular, fixed supply stations which are usually placed on the edge of the field by the farmer and which can be moved are known. For example, a fixed supply station can consist of a standing reloading bin to be placed at the edge of the field and which can be moved by a truck or of a trailer that can be moved by a tractor.

Dedicated supply vehicles are also known, for example a dedicated pick-up or tractor with a tank.

The fixed supply station or the supply vehicle is supplied with inputs manually by the driver or by another operator.

In addition, to move the fixed supply station, the use of a dedicated vehicle or tool and a human operator are necessary, at least during the movement of the fixed supply station.

To save time, the farmer may decide not to move the fixed supply station or the supply vehicle, but in this case the distances between each supply increase rapidly on large plots of land.

Publication EP 2855102B1 already discloses that the vehicle can be reloaded at the station autonomously when an input threshold is reached. In addition, the positioning of the station in the plot is optimized according to the mission. The station is positioned manually. A supervisor can help the user to choose the position of the station.

The present invention aims to overcome at least one of these disadvantages by limiting the intervention of an operator to the sole operations of positioning the supply and/or maintenance station in the plot of land and reloading it with input(s).

To this end, the invention relates to an agricultural supply equipment adapted and intended to be placed in a plot of land,
said equipment comprising at least:
   one supply and/or maintenance station comprising at least one storage area adapted and intended for storing, for example, at least one input,
   one autonomous agricultural vehicle adapted and intended to perform at least one agricultural task in said plot of land and comprising at least one area for receiving, for example, at least one input,
said agricultural equipment is characterized in that it comprises:
   a control unit for controlling the travel and/or position of said at least one autonomous agricultural vehicle and/or said supply and/or maintenance station configured at least to control the travel of said at least one autonomous agricultural vehicle and/or said supply and/or maintenance station inside said plot of land,
   said plot of land comprising at least one work area in which at least one agricultural task is being performed by said at least one autonomous agricultural vehicle and at least one area to be worked in which at least one agricultural task is to be performed by said at least one autonomous agricultural vehicle, said work area and said area to be worked being distinct from one another,
   said control unit being configured to control the travel of the supply and/or maintenance station from the work area to the area to be worked if said at least one autonomous agricultural vehicle has to move to perform at least one agricultural task in the area to be worked, this travel of the supply and/or maintenance station being independent of or dependent on the travel of said at least one autonomous agricultural vehicle from the work area to the area to be worked.

The invention also relates to a supply and/or maintenance method implementing an agricultural supply and/or maintenance equipment adapted and intended to be placed in a plot of land, characterized in that said equipment complies with the invention and in that the method comprises at least:
a step of moving the supply and/or maintenance station, during which a travel of the supply and/or maintenance station from the work area to the area to be worked is carried out and is controlled by the control unit if said at least one autonomous agricultural vehicle must move to perform at least one agricultural task in the area to be worked, this travel of the supply and/or maintenance station being independent of or dependent on the travel of said at least one autonomous agricultural vehicle from the work area to the area to be worked.

The invention will be better understood thanks to the following description, which relates to several preferred embodiments given as non-limiting examples and explained with reference to the attached schematic drawings, in which:

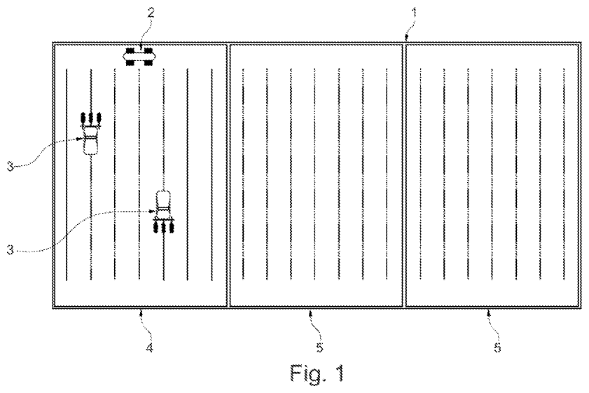

FIG. 1 represents a plot of land which comprises an agricultural supply and/or maintenance equipment according to the invention and showing two autonomous agricultural vehicles and a supply and/or maintenance station in a work area of the plot of land,

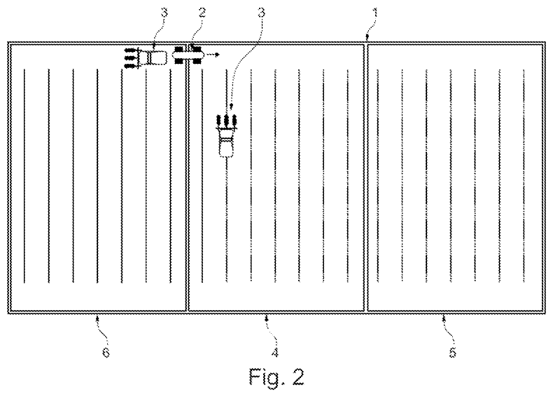

FIG. 2 represents a plot of land which comprises an agricultural supply equipment according to the invention, and showing an autonomous agricultural vehicle hitched to the supply and/or maintenance station in a work area of the plot of land during a second travel of the autonomous agricultural vehicle from the work area to the area to be worked, and

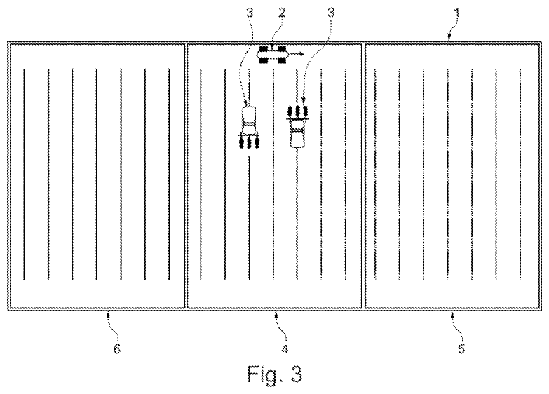

FIG. 3 represents a plot of land which comprises at least one agricultural supply and/or maintenance equipment according to the invention and showing two autonomous agricultural vehicles and a supply and/or maintenance station in another work area of the plot of land.

An agricultural supply and/or maintenance equipment adapted and intended to be placed in a plot of land 1 comprises at least:
one supply and/or maintenance station 2 comprising at least one storage area adapted and intended for storing, for example, at least one input,
one autonomous agricultural vehicle 3 adapted and intended to perform at least one agricultural task in said plot of land 1 and comprising at least one area for receiving, for example, at least one input.

According to the invention, said agricultural equipment is characterized in that it comprises:
a travel and/or position control unit for said at least one autonomous agricultural vehicle 3 and/or for said supply and/or maintenance station 2 configured at least to control the travel of said at least one autonomous agricultural vehicle 3 and/or for said supply and/or maintenance station 2 inside said plot of land 1,
said plot of land 1 comprising at least one work area 4 in which at least one agricultural task is being performed by said at least one autonomous agricultural vehicle 3 and at least one area to be worked 5 in which at least one agricultural task is to be performed by said at least one autonomous agricultural vehicle 3, said work area 4 and said area to be worked 5 being distinct from one another,
said control unit being further configured to control the travel of the supply and/or maintenance station 2 from the work area 4 to the area to be worked 5, if said at least one autonomous agricultural vehicle 3 must move to perform at least one agricultural task in the area to be worked 5, this travel of the supply and/or maintenance station 2 being independent of or dependent on the travel of said at least one autonomous agricultural vehicle 3 from the work area 4 to the area to be worked 5.

Advantageously, the agricultural equipment according to the invention makes it possible to position and move said at least one supply and/or maintenance station 2 in the plot of land 1, so that it can be located as much as possible in the work area 4. In fact, when said at least one autonomous agricultural device 3 performs at least one agricultural task in the work area 4, then the supply and/or maintenance station 2 is also located in this work area 4 (FIGS. 1 and 3). When said at least one autonomous agricultural vehicle 3 must perform at least one agricultural task in the area to be worked 5 and move from the work area 4 to the area to be worked 5, then the supply and/or maintenance station 2 moves or is moved from the work area 4 to the area to be worked 5 (FIG. 2). Thus, the supply and/or maintenance station 2 follows said at least one autonomous agricultural device 3 during the work of said at least one autonomous agricultural vehicle 3. The position of the supply and/or maintenance station 2 is thus optimized to make it possible to limit the distance between the supply and/or maintenance station 2 and said at least one autonomous agricultural vehicle 3. The invention is particularly interesting in the case of large plots of land 1 on which said at least one autonomous agricultural vehicle 3 requires frequent supplies. In fact, the invention allows the travels of said at least one autonomous agricultural vehicle 3 to the supply and/or maintenance station 2 to obtain supplies to be optimized, by reducing the distances. The travel of the supply and/or maintenance station 2 can be independent of the travel of said at least one autonomous agricultural vehicle 3 from the work area 4 to the area to be worked 5. In this case, the supply and/or maintenance station 2 is arranged to move for example autonomously from the work area 4 to the area to be worked 5. The travel of the supply and/or maintenance station 2 can be dependent on the travel of said at least one autonomous agricultural vehicle 3 from the work area 4 to the area to be worked 5. In this case, said at least one autonomous agricultural vehicle 3 is arranged to move the supply and/or maintenance station 2 from the work area 4 to the area to be worked 5.

A plot of land 1 means, for example, agricultural land having a delimited perimeter.

The supply and/or maintenance station 2 is designed to store said at least one input and/or spare or wear parts in said at least one storage area. The supply and/or maintenance station 2 can also be designed to replace wear parts and/or provide assistance in the event of a breakdown. As such, the supply and/or maintenance station 2 can be equipped with an automated arm and/or other tools intended to perform maintenance and/or replace wear parts and/or provide assistance in case of a breakdown.

The supply and/or maintenance station 2 can be autonomous and thus be able to move at least in the plot of land 1 without the intervention of a driver or a human operator. The supply and/or maintenance station 2 then operates in the same way as one of the autonomous agricultural vehicles 3, with the difference that it is not intended to perform an agricultural operation in the plot of land 1. The travel and/or position control unit controlling the at least one autonomous agricultural vehicle 3 also controls the travel and/or position of the supply and/or maintenance station 2 if the latter is autonomous. The travel of the supply and/or maintenance station 2 can then be generated by a travel means assembly composed of at least an energy source such as at least an electric battery and/or an electric motor and/or a combustion engine coupled to a generator, as well as of at least a travel means such as a wheel, a track or similar.

The storage area(s) can preferably consist of a tank and/or a container and/or a hopper and/or a silo and/or a battery and/or a bag or similar.

An input can be selected from fuel and/or electrical energy and/or fertilizer and/or seeds and/or plant protection products and/or water or similar. An input means a product, an energy or a substance used by the autonomous agricultural vehicle 3 and/or by its agricultural tool to perform an agricultural operation or an agricultural task in the plot of land 1.

An autonomous agricultural vehicle 3 is an agricultural vehicle that is able to move at least in the plot of land 1 without the intervention of a driver or a human operator. The autonomous agricultural vehicle 3 can be an agricultural robot. Said autonomous agricultural vehicle 3 can comprise at least one sensor to allow the guiding and navigation of said autonomous agricultural vehicle 3. Said autonomous agricultural vehicle 3 can comprise at least wireless communication means. These wireless communication means make it possible to communicate with the travel and/or position control unit which sends instructions to the autonomous agricultural vehicle 3. The travel of the autonomous agricultural vehicle 3 is preferably generated by a travel means assembly composed of at least an energy source such as at least an electric battery and/or an electric motor and/or a heat engine coupled to a generator as well as at least a travel means such as a wheel, a caterpillar track or similar. The autonomous agricultural vehicle 3 can also comprise at least one agricultural tool making it possible to perform an agricultural operation or an agricultural task. Said at least one agricultural tool can be fixedly mounted on the autonomous agricultural vehicle 3 or coupled to the latter in a detachable manner. The agricultural operation or the agricultural task that can be performed by the autonomous agricultural vehicle 3 as well as by said at least one agricultural tool can for example consist of one of the following operations/tasks or a combination thereof: plowing, tillage, weeding, seeding, fertilizing, spreading, spraying, mowing, tedding, swathing, baling, bale wrapping, harvesting.

The reception area(s) can preferably consist of a tank and/or a hopper and/or a container and/or a silo and/or a battery and/or a bag or similar.

The travel and/or position control unit for the said at least one autonomous agricultural vehicle 3 and/or for said supply and/or maintenance station 2 is designed to manage the travels of said at least one autonomous agricultural vehicle 3 and/or of said supply and/or maintenance station 2. Several travel strategies are possible. The control unit can comprise a navigation and/or guide module for controlling the navigation and/or guiding of said at least one autonomous agricultural vehicle 3 and/or of said supply and/or maintenance station 2. The control unit is preferably remote from said at least one autonomous agricultural vehicle 3 and/or of said supply and/or maintenance station 2. In this case, the control unit, said at least one autonomous agricultural vehicle 3 and/or said supply and/or maintenance station 2 preferably respectively comprise wireless communication means. Alternatively, the control unit can be local, i.e. be part of said at least one autonomous agricultural vehicle 3. The travels and positions of said supply and/or maintenance station 2 and/or of said at least one autonomous agricultural vehicle 3 can be known in advance before starting work on the plot of land 1. In this case, for example, the control unit is configured to control the travels on the basis of the supply forecasts with adjustment according to actual consumptions. Alternatively, the travels and positions of said supply and/or maintenance station 2 and/or of said at least one autonomous agricultural vehicle 3 and the reloadings of said at least one autonomous agricultural vehicle 3 are made in a “reactive” manner, after checking the levels of said at least one autonomous agricultural vehicle 3 during work. In this case, for example, the control unit does not control the travels on the basis of the forecasts of the reloadings or travels. The control unit can comprise a programmable module integrating for example a computer program or an artificial intelligence.

The work area 4 corresponds to a portion of the plot of land 1 inside which at least one agricultural task is being performed by said at least one autonomous agricultural vehicle 3.

The area to be worked 5 corresponds to a portion of the plot of land 1 inside which at least one agricultural task is to be performed by said at least one autonomous agricultural vehicle 3.

The work area 4 and the area to be worked 5 are distinct from one another, i.e. there is no overlapping or covering of the work area 4 with the area to be worked 5. The work area 4 and the area to be worked 5 are preferably separated from one another in a virtual manner, in order to distribute the work and facilitate the control of said at least one autonomous agricultural vehicle 3. Preferably, there is no distinction or physical separation between them in the actual plot of land 1.

A worked area 6 corresponds to a portion of the plot of land 1 inside which said at least one agricultural task is finished and/or is considered to be finished by said at least one autonomous agricultural vehicle 3. A portion of the plot of land 1 can be considered to be a worked area 6 if said portion is worked above a certain threshold, which can for example be 95 percent, and if finishing it to 100 percent would involve significant travels, to avoid wasting time or inputs for a minor increase in the harvest.

Preferably, in the agricultural supply and/or maintenance equipment according to the invention, said at least one supply and/or maintenance station 2 comprises at least first coupling means, said at least one autonomous agricultural vehicle 3 comprises at least second coupling means adapted and intended to be connected to said first coupling means, to allow said autonomous agricultural vehicle 3 to tow or push said supply and/or maintenance station 2 and said control unit is configured:
to control a first travel of said at least one autonomous agricultural vehicle 3 towards said supply and/or maintenance station 2, if said autonomous agricultural vehicle 3 and the supply and/or maintenance station 2 are located in the work area 4 and uncoupled from each other, in order to enable the coupling of the first coupling means and the second coupling means together,
then following the first travel, to control a second travel of said autonomous agricultural vehicle 3 to which said supply and/or maintenance station 2 is coupled from the work area 4 to the area to be worked 5, to allow the travel of the supply and/or maintenance station 2 from the work area 4 to the area to be worked 5 (FIG. 2).

Advantageously, the travel of the supply and/or maintenance station(s) 2 from a work area 4 to an area to be worked 5 is carried out by the autonomous agricultural vehicle(s) 3. The supply and/or maintenance station 2 is towed and/or pushed by said at least one autonomous agricultural vehicle 3. More particularly, FIG. 2 shows that the travel of the supply and/or maintenance station 2 is dependent on the travel of said at least one autonomous agricultural vehicle 3 from the work area 4 to the area to be worked 5. During the second travel, said at least one autonomous agricultural vehicle 3 moves the supply and/or maintenance station 2 from the work area 4 to the area to be worked 5, since the supply and/or maintenance station 2 is coupled to said at least one autonomous agricultural vehicle 3 by the first and second coupling means. As a result, the supply and/or maintenance station 2 can have a simplified design since it only requires to be adapted to be towed and/or guided and/or pushed by said at least one autonomous agricultural vehicle 3. The chronology of the travel of the supply and/or maintenance station 2 by the autonomous agricultural device 3 is preferably optimized to avoid unnecessary travels. For example, the autonomous agricultural vehicle 3 will move the supply and/or maintenance station 2 when it will travel from the work area 4 to the area to be worked 5, it will not go “back” to get it in a worked area 6 in which it has already worked.

The first coupling means and the second coupling means are designed to be mechanically connected together, for example by shape complementarity. Thus, the supply and/or maintenance station 2 can be coupled to said at least one autonomous agricultural vehicle 3 to be towed and/or pushed by it. The first coupling means and the second coupling means are designed to adopt a position in which they are coupled/locked and a position in which they are uncoupled/unlocked from each other. The change from one position to the other can be automatic, i.e. without human intervention. This change can for example be made by activating or deactivating an electromagnet connecting the first and second coupling means or even by an automatically controlled actuator making it possible to engage or disengage a coupling hook in a ring. The first and second coupling means can comprise at least a hook and/or a drawbar and/or a ring.

Preferably, the supply and/or maintenance station 2 is coupled to or uncoupled from the autonomous agricultural vehicle 3 or vice versa takes place autonomously. The first and second coupling means can for example consist of two electromagnets which come into contact with each other during coupling. They can be activated automatically so that the connection between the first and second coupling means is maintained for the time required, then released again once the travel is finished. In another alternative, the first and second coupling means consist of a hook and a ring. The hook and/or the ring are mounted on actuators which make it possible to couple and uncouple the supply and/or maintenance station 2 to/from the autonomous agricultural vehicle 3, or vice versa, selectively and automatically. The coupling and/or uncoupling procedure can be automated via an electronic monitor and at least one sensor (contact, optical, proximity, or similar) indicating the time when the coupling or uncoupling procedure must be started or stopped.

Preferably in the agricultural supply and/or maintenance equipment according to the invention, said control unit is configured to control, after the second travel, a third travel of said at least one autonomous agricultural vehicle 3 in a direction away from said supply and/or maintenance station 2, if said autonomous agricultural vehicle 3 and the supply and/or maintenance station 2 are located in the area to be worked 5 and coupled together by said first and second coupling means, in order to make it possible to uncouple the first coupling means and the second coupling means from each other.

Advantageously, as shown on FIG. 3, after the third travel, said at least one autonomous agricultural vehicle 3 and the supply and/or maintenance station 2 are again independent of each other. Said at least one autonomous agricultural vehicle 3 can perform at least one agricultural task in the area to be worked 5 and move independently of the supply and/or maintenance station 2 in the area to be worked 5.

Preferably, in the agricultural supply and/or maintenance equipment according to the invention, said control unit is configured to check that the position of the supply and/or maintenance station 2 and the position of the said at least one autonomous agricultural vehicle 3 are located inside the plot of land 1.

Advantageously, the supply and/or maintenance station 2 is always placed inside the outline of the plot of land 1. In addition, said at least one autonomous agricultural vehicle 3 cannot leave it for safety reasons.

Preferably, in the agricultural supply and/or maintenance equipment according to the invention, said control unit is configured to control a supply and/or maintenance travel of said at least one autonomous agricultural vehicle 3 towards said supply and/or maintenance station 2, if said autonomous agricultural vehicle 3 and the supply and/or maintenance station 2 are located in the work area 4 or the area to be worked 5 and are uncoupled from each other, so as to allow the distribution of at least one input from the storage area of the supply and/or maintenance station 2 to the reception area of said at least one autonomous agricultural vehicle 3 and/or the execution of a maintenance or assistance operation for said at least one autonomous agricultural vehicle 3.

Advantageously, the result is that the supply and/or maintenance travel can take place at least partially or totally without the intervention of a human operator, i.e. autonomously. The supply and/or maintenance station 2 can be used to allow the supply of said at least one autonomous agricultural vehicle 3 with inputs of all types (fuel, electrical energy, fertilizers, seeds, plant protection products, water, etc.). The supply and/or maintenance station 2 can also be used to perform maintenance and/or repair of said at least one autonomous agricultural vehicle 3. For example, wear parts may be replaced and/or assistance may be provided in case of a breakdown. The maintenance/repair operations can be performed by a human operator or a PLC. The supply and/or maintenance station 2 is located in an advantageous position to reduce the distance to be traveled by the defective autonomous agricultural vehicle 3.

Preferably, the supply is performed autonomously without the intervention of a human operator, while respecting safety and environmental standards. When reloading solid inputs, such as seeds, solid fertilizers, etc., the operation can be performed using an auger conveyor mounted on the supply and/or maintenance station 2, by a chute conveying the product by means of pneumatic pressure or by gravity. Similarly, the supply and/or maintenance station 2 can be built in the shape of an arch below which the autonomous agricultural vehicle 3 can travel. In this case, the reloading of solid inputs can be performed using a hatch opening the storage area of the supply and/or maintenance station 2 that the autonomous agricultural vehicles 3 actuates as it passes. The reloading of liquid inputs, such as water, fuel, liquid fertilizer, plant protection products, etc. can, for example, be performed by pumping the input from the storage area of the supply and/or maintenance station 2 to the reception area of the autonomous agricultural vehicle 3 via a pipe. Once again, reloading by gravity as mentioned previously is possible. Reloading with electrical energy can be performed by guiding a plug located on the supply and/or maintenance station 2 towards a plug socket located on the autonomous agricultural vehicle 3 by means of a cone allowing alignment and autonomous plugging. The positions of the plug and plug socket can be reversed.

Preferably, in the agricultural supply and/or maintenance equipment according to the invention, the control unit is configured to control an “independent” travel of said at least one autonomous agricultural vehicle 3 from the work area 4 to the area to be worked 5, if said autonomous agricultural vehicle 3 is located in the work area 4 and is uncoupled from the supply and/or maintenance station 2, in order to allow said autonomous agricultural vehicle 3 to perform at least one agricultural task in the area to be worked 5.

Advantageously, said at least one autonomous agricultural vehicle 3 can travel from the work area 4 to the area to be worked 5 independently of the supply and/or maintenance station 2 to perform at least one agricultural task in the area to be worked 5.

According to a first variant embodiment, the agricultural supply and/or maintenance equipment according to the invention comprises a plurality of autonomous agricultural vehicles 3 and said control unit is configured to control the travel of said plurality of autonomous agricultural vehicles 3 inside said plot of land 1.

Advantageously, when said autonomous agricultural vehicles 3 perform at least one agricultural task in the work area 4, then the supply and/or maintenance station 2 is also located in this work area 4 (FIGS. 1 and 3). When at least one of said autonomous agricultural vehicles 3 must perform at least one agricultural task in the area to be worked 5 and travel from the work area 4 to the area to be worked 5, then the supply and/or maintenance station 2 travels or is travelled from the work area 4 to the area to be worked 5 (FIG. 2). Thus, the supply and/or maintenance station 2 follows the autonomous agricultural vehicles 3 during their work. The position of the supply and/or maintenance station 2 is thus optimized in order to limit the distance between the supply and/or maintenance station 2 and the autonomous agricultural vehicle 3. The travel of the supply and/or maintenance station 2 can be independent of the travel of the autonomous agricultural vehicles 3 from the work area 4 to the area to be worked 5. In this case, the supply and/or maintenance station 2 is arranged to travel for example autonomously from the work area 4 to the area to be worked 5. The travel of the supply and/or maintenance station 2 can be dependent on the travel of at least one of the autonomous agricultural vehicles 3 from the work area 4 to the area to be worked 5. In this case, said at least one of the autonomous agricultural vehicles 3 is arranged to travel the supply and/or maintenance station 2 from the work area 4 to the area to be worked 5.

Preferably according to a first possibility of the first variant embodiment, in the agricultural supply and/or maintenance equipment, the control unit is configured to control the first travel and the second travel of a first autonomous agricultural vehicle 3, if the other autonomous agricultural vehicles 3 located in the work area 4 do not need to be supplied and/or maintained by said supply and/or maintenance station 2.

Advantageously in this case, the first autonomous agricultural vehicle 3 travelling from the work area 4 to the area to be worked 5 takes the supply and/or maintenance station 2 with it, provided that the other autonomous agricultural vehicles 3 still in the work area 4 do not need it.

Preferably according to a second alternative possibility of the first variant embodiment, in the agricultural supply and/or maintenance equipment, the control unit is configured to control the “independent” travel of the autonomous agricultural vehicles 3 from the work area 4 to the area to be worked 5, with the exception of a last autonomous agricultural vehicle 3, and then successively to control the first travel and the second travel of said last autonomous agricultural vehicle 3.

Advantageously in this case, the last autonomous agricultural vehicle 3 travelling from the work area 4 to the area to be worked 5 takes the supply and/or maintenance station 2 with it (FIG. 2).

Preferably, the supply and/or maintenance station 2 is active and comprises at least one engine and said at least one autonomous agricultural vehicle 3 comprises at least one engine.

In this case, the supply and/or maintenance station 2 can be provided with an integrated travel module. The supply and/or maintenance station 2 can assist said at least one autonomous agricultural vehicle 3 for its travel. Preferably, the navigation remains entirely managed by the control unit which controls said at least one autonomous agricultural vehicle 3. This configuration is particularly useful in the case of a supply and/or maintenance station 2 of large dimensions and/or whose mass would be difficult to move by an autonomous agricultural vehicle 3 alone.

Alternatively and preferably, the supply and/or maintenance station 2 is passive and does not comprise an engine and said at least one autonomous agricultural vehicle 3 comprises at least one engine.

Advantageously, the supply and/or maintenance station 2 is not motorized and the autonomous agricultural vehicle 3 is therefore fully responsible for travelling the supply and/or maintenance station 2. The supply and/or maintenance station 2 can be towed and/or pushed by said at least one autonomous agricultural vehicle 3. For example, the supply and/or maintenance station 2 could be both pushed and pulled if it would be moved by several autonomous agricultural vehicles 3.

The invention also relates to a supply and/or maintenance method implementing an agricultural supply and/or maintenance equipment adapted and intended to be placed in a plot of land 1.

According to the invention, the method is characterized in that said equipment complies with the invention as described previously and in that the method comprises at least:
a step of travelling the supply and/or maintenance station 2, during which a travel of the supply and/or maintenance station 2 from the work area 4 to the area to be worked 5 is made and is controlled by the control unit if said at least one autonomous agricultural vehicle 3 must travel to perform at least one agricultural task in the area to be worked 5, this travel of the supply and/or maintenance station 2 being independent of or dependent on the travel of said at least one autonomous agricultural vehicle 3 from the work area 4 to the area to be worked 5.

Advantageously, the method makes it possible to position and travel said at least one supply and/or maintenance station 2 in the plot of land 1, so that it can be located as much as possible in the work area 4. In fact, when said at least one autonomous agricultural vehicle 3 performs at least one agricultural task in the work area 4, then the supply and/or maintenance station 2 is also located in this work area 4 (FIGS. 1 and 3). When said at least one autonomous agricultural vehicle 3 must perform at least one agricultural task in the area to be worked 5 and travel from the work area 4 to the area to be worked 5, then the supply and/or maintenance station 2 travels or is travelled from the work area 4 to the area to be worked 5 (FIG. 2). Thus, the supply and/or maintenance station 2 follows said at least one autonomous agricultural vehicle 3 during the work of said at least one autonomous agricultural vehicle 3. The position of the supply and/or maintenance station 2 is thus optimized in order to allow the distance between the supply and/or maintenance station 2 and said at least one autonomous agricultural vehicle 3 to be limited. The invention is particularly interesting in the case of large plots of land 1 on which said at least one autonomous agricultural vehicle 3 requires frequent supplies. The travel of the supply and/or maintenance station 2 can be independent of the travel of said at least one autonomous agricultural vehicle 3 from the work area 4 to the area to be worked 5. In this case, the supply and/or maintenance station 2 travels for example autonomously from the work area 4 to the area to be worked 5. The travel of the supply and/or maintenance station 2 can be dependent on the travel of said at least one autonomous agricultural vehicle 3 from the work area 4 to the area to be worked 5. In this case, said at least one autonomous agricultural vehicle 3 travels the supply and/or maintenance station 2 from the work area 4 to the area to be worked 5.

Preferably, the supply and/or maintenance method according to the invention comprises:
a coupling step, during which a first travel of said at least one autonomous agricultural vehicle 3 towards said supply and/or maintenance station 2 is made and is controlled by said control unit, if said autonomous agricultural vehicle 3 and the supply and/or maintenance station 2 are located in the work area 4 and uncoupled from each other, in order to allow coupling the first coupling means and the second coupling means together,
a step of travelling the supply and/or maintenance station 2, after the coupling step, during which a second travel of said autonomous agricultural vehicle 3 to which said supply and/or maintenance station 2 is coupled is carried out from the work area 4 to the area to be worked 5 and is controlled by said control unit, to allow the travel of the supply and/or maintenance station 2 from the work area 4 to the area to be worked 5.

Advantageously, during the step of travelling the supply and/or maintenance station 2, the travel of the supply and/or maintenance station(s) 2 from a work area 4 to an area to be worked 5 is carried out by the autonomous agricultural vehicle(s) 3. The supply and/or maintenance station 2 is towed and/or pushed by said at least one autonomous agricultural vehicle 3. More particularly, FIG. 2 shows that the travel of the supply and/or maintenance station 2 is dependent on the travel of said at least one autonomous agricultural vehicle 3 from the work area 4 to the area to be worked 5. During the second travel, said at least one autonomous agricultural vehicles 3 travels the supply and/or maintenance station 2 from the work area 4 to the area to be worked 5 since the supply and/or maintenance station 2 is coupled to said at least one autonomous agricultural vehicle 3 by the first and second coupling means. As a result, the supply and/or maintenance station 2 can have a simplified design since it only needs to be adapted to be towed and guided by said at least one autonomous agricultural vehicle 3.

Preferably, the supply and/or maintenance method according to the invention comprises:
an uncoupling step, during which a third travel of said at least one autonomous agricultural vehicle 3 in a direction away from said supply and/or maintenance station 2 is carried out and is controlled by said control unit, if said autonomous agricultural vehicle 3 and the supply and/or maintenance station 2 are located in the area to be worked 5 and coupled together by said first and second coupling means, in order to allow uncoupling the first coupling means and the second coupling means from each other.

Advantageously, as shown on FIG. 3, at the end of the uncoupling step and the third travel, said at least one autonomous agricultural vehicle 3 and the supply and/or maintenance station 2 are again independent of each other. Said at least one autonomous agricultural vehicle 3 can perform at least one agricultural task in the area to be worked 5.

Preferably, the supply and/or maintenance method according to the invention comprises:
a supply and/or maintenance travel step during which a supply and/or maintenance travel of said at least one autonomous agricultural vehicle 3 towards said supply station is carried out and is controlled by said control unit, if said autonomous agricultural vehicle 3 and the supply and/or maintenance station 2 are located in the work area 4 or the area to be worked 5 and are uncoupled from each other, so as to allow the distribution of at least one input from the storage area of the supply and/or maintenance station 2 to the reception area of said at least one autonomous agricultural vehicle 3 and/or the execution of a maintenance operation for said at least one autonomous agricultural vehicle 3.

Advantageously, the result is that the supply and/or maintenance travel step can be performed at least partially or totally without the intervention of a human operator, i.e. autonomously. After the supply and/or maintenance travel step, the supply and/or maintenance station 2 can be used to enable the supply to said at least one autonomous agricultural vehicle 3 with inputs of all types (fuel, electrical energy, fertilizers, seeds, plant protect products, water, etc.). The supply and/or maintenance station 2 can also be used to allow to perform maintenance and/or repair of said at least one autonomous agricultural vehicle 3. For example, wear parts can be replaced and/or assistance provided in case of a breakdown. The maintenance/repair operations can be performed by a human operator or a PLC. The supply and/or maintenance station 2 is located in an advantageous position to reduce the distance to be traveled by the defective autonomous agricultural vehicle 3.

Preferably, the supply and/or maintenance method according to the invention comprises:
a step of travelling from the work area 4 to the area to be worked 5, during which an “independent” movement of said at least one autonomous agricultural vehicle 3 from the work area 4 to the area to be worked 5 is carried out and is controlled by said control unit, if said autonomous agricultural vehicle 3 is located in the work area 4 and is uncoupled from the supply and/or maintenance station 2, so as to allow said autonomous agricultural vehicle 3 to perform at least one agricultural task in the area to be worked 5.

Advantageously, during the step of travelling from the work area 4 to the area to be worked 5, said at least one autonomous agricultural vehicle 3 can move from the work area 4 to the area to be worked 5 independently of the supply and/or maintenance station 2 to perform at least one agricultural task in the area to be worked 5.

Preferably, the supply and/or maintenance method according to the invention comprises a step of loading/reloading the supply and/or maintenance station 2, during which at least one storage area of the supply and/or maintenance station 2 is loaded or reloaded with input.

Preferably, the step of loading/reloading the supply and/or maintenance station 2 is performed by a human operator.

Preferably, the supply and/or maintenance method according to the invention comprises a step of positioning the supply and/or maintenance station 2 on the plot of 1, during which the supply and/or maintenance station 2 is moved from a storage area to the plot of land 1.

Preferably, this step of positioning the supply and/or maintenance station 2 on the plot of land 1 is performed with the intervention of a human operator and not autonomously. Currently, in fact, the use of the public highways by autonomous vehicles is still highly complex as regards the legal and safety aspects.

Obviously, the invention is not limited to the embodiments described and shown in the attached drawings. Modifications remain possible, in particular as regards the composition of the various elements or the substitution by technical equivalents without departing from the scope of protection of the invention.

1. An agricultural supply and/or maintenance equipment adapted and intended to be placed in a plot of land, said equipment comprising at least:
one supply and/or maintenance station comprising at least one storage area adapted and intended for storing, for example, at least one input,
one autonomous agricultural vehicle adapted and intended to perform at least one agricultural task in said plot of land and comprising at least one area for receiving, for example, at least one input, and
a control unit for controlling the travel and/or position of said at least one autonomous agricultural vehicle and/or of said supply and/or maintenance station configured at least to control the travel of said at least one autonomous agricultural vehicle and/or of said supply and/or maintenance station inside said plot of land,
said plot of land comprising at least one work area in which at least one agricultural task is being performed by said at least one autonomous agricultural vehicle and at least one area to be worked in which at least one agricultural task is to be performed by said at least one autonomous agricultural vehicle, said work area and said area to be worked being distinct from one another,
said control unit being configured to control the travel of the supply and/or maintenance station from the work area to the area to be worked if said at least one autonomous agricultural vehicle must travel to perform at least one agricultural task in the area to be worked, this travel of the supply and/or maintenance station being independent of or dependent on the travel of said at least one autonomous agricultural vehicle from the work area to the area to be worked.

2. The agricultural supply and/or maintenance equipment according to claim 1, wherein
said at least one supply and/or maintenance station comprises at least first coupling means,
said at least one autonomous agricultural vehicle comprises at least second coupling means adapted and intended to be connected to said first coupling means, to allow said autonomous agricultural vehicle to tow or push said supply and/or maintenance station,
said control unit is configured:
to control a first travel of said at least one autonomous agricultural vehicle towards said supply and/or maintenance station, if said autonomous agricultural vehicle and the supply and/or maintenance station are located in the work area and uncoupled from each other, in order to allow coupling of the first coupling means and the second coupling means together,
then successively to the first travel, to control a second travel of said autonomous agricultural vehicle to which said supply and/or maintenance station is coupled from the work area to the area to be worked, so as to allow the travel of the supply and/or maintenance station from the work area to the area to be worked.

3. The agricultural supply and/or maintenance equipment according to claim 2, wherein said control unit is configured to control, successively to the second travel, a third travel of said at least one autonomous agricultural vehicle in a direction away from said supply and/or maintenance station, if said autonomous agricultural vehicle and the supply and/or maintenance station are located in the area to be worked and coupled together by said first and second coupling means, in order to allow uncoupling the first coupling means and the second coupling means from each other.

4. The agricultural supply and/or maintenance equipment according to claim 1, wherein said control unit is configured to control a supply and/or maintenance travel of said at least one autonomous agricultural device towards said supply station, if said autonomous agricultural vehicle and the supply and/or maintenance station are located in the work area or the area to be worked and are uncoupled from each other, so as to allow the distribution of at least one input from the storage area of the supply and/or maintenance station to the reception area of said at least one autonomous agricultural vehicle and/or the execution of a maintenance operation of said at least one autonomous agricultural vehicle.

5. The agricultural supply and/or maintenance equipment according to claim 1, further comprising a plurality of autonomous agricultural vehicles, wherein said control unit is configured to control the travel of said plurality of autonomous agricultural vehicles inside said plot of land.

6. The agricultural supply and/or maintenance equipment according to claim 5, wherein the control unit is configured to control the first travel and the second travel of a first autonomous agricultural vehicle, if the other autonomous agricultural vehicles located in the work area do not need to be supplied and/or maintained by said supply and/or maintenance station.

7. The agricultural supply and/or maintenance equipment according to claim 1, wherein the supply and/or maintenance station is active and comprises at least one engine and in that said at least one autonomous agricultural vehicle comprises at least one engine.

8. A supply and/or maintenance method implementing an agricultural supply and/or maintenance equipment adapted and intended to be placed in a plot of land, wherein said equipment is in accordance with claim 1 and the method comprises at least:
a step of travelling the supply and/or maintenance station, during which a travel of the supply and/or maintenance station from the work area to the area to be worked is carried out and is controlled by the control unit if said at least one autonomous agricultural vehicle must travel to perform at least one agricultural task in the area to be worked, this travel of the supply and/or maintenance station being independent of or dependent on the travel of said at least one autonomous agricultural vehicle from the work area to the area to be worked.

9. The supply and/or maintenance method according to claim 8, further comprising:
a coupling step, during which a first travel of said at least one autonomous agricultural vehicle towards said supply and/or maintenance station is carried out and is controlled by said control unit, if said autonomous agricultural vehicle and the supply and/or maintenance station are located in the work area and uncoupled from each other, in order to allow coupling the first coupling means and the second coupling means together,
a step of travelling the supply and/or maintenance station, successively to the coupling step, during which a second travel of said autonomous agricultural vehicle to which said supply and/or maintenance station is coupled is carried out from the work area to the area to be worked and is controlled by said control unit, so as to allow the travel of the supply and/or maintenance station from the work area to the area to be worked.

10. The supply and/or maintenance method according to claim 8, further comprising:
an uncoupling step, during which a third travel of said at least one autonomous agricultural vehicle in a direction away from said supply and/or maintenance station is carried out and is controlled by said control unit, if said autonomous agricultural vehicle and the supply and/or maintenance station are located in the area to be worked and coupled together by said first and second coupling means, in order to allow uncoupling the first coupling means and the second coupling means from each other.

11. The supply and/or maintenance method according to claim 8, further comprising:
a supply and/or maintenance travel step during which a supply and/or maintenance travel of said at least one autonomous agricultural vehicle towards said supply station is carried out and is controlled by said control unit, if said autonomous agricultural vehicle and the supply and/or maintenance station are located in the work area or the area to be worked and are uncoupled from each other, so as to allow the distribution of at least one input from the storage area of the supply and/or maintenance station to the reception area of said at least one autonomous agricultural vehicle and/or the execution of a maintenance operation of said at least one autonomous agricultural vehicle.
